(19) United States
(12) Patent Application Publication
(10) Pub. No.: US 2004/0025123 A1
(43) Pub. Date: Feb. 5, 2004

(54) System and method to facilitate evaluation of integrated circuits through delay testing

(76) Inventor: Josey G. Angilivelil, Sachse, TX (US)

Correspondence Address: W. Daniel Swayze, Jr., Texas Instruments Incorporated, M/S 3999, PO Box 655474, Dallas, TX, 75265, US

(21) Appl. No.: 10/630,615

(22) Filed: Jul. 30, 2003

Related U.S. Application Data
(60) Provisional application No. 60/400,425, filed on Aug. 1, 2002.

(51) Int. Cl. G06F 17/50

(52) U.S. Cl. 716/4

(57) ABSTRACT

An approach is disclosed herein to facilitate evaluating integrated circuit (IC) chips. A set of critical paths are determined for a design associated with the IC chip, at least some of which critical paths are based on timing characteristics for the design (e.g., timing margin or slack). Multiple sets of test patterns are generated for the set of critical paths based on desired performance criteria. One or more of the plurality of sets of test patterns can be applied to the IC chip to provide corresponding test data that can be utilized to evaluate chip performance and/or improve the chip yield for the IC design.

### CROSS REFERENCE TO RELATED APPLICATION

This application claims the benefit of U.S. provisional patent application No. 60/400,425, which was filed Aug. 1, 2002, and entitled “Delay testing based speed grading in deep submicron technologies,” the entire contents of which is incorporated herein by reference.

### TECHNICAL FIELD

The present invention relates generally to systems and methods for integrated circuit (IC) fabrication and more particularly to systems and methods to facilitate evaluation of ICs through delay testing.

### BACKGROUND OF THE INVENTION

In the process flow of semiconductor integrated circuits (ICs), various tools have been developed to facilitate all aspects from design through fabrication. As the industry moves forward into deep submicron (DSM) and ultra DSM (UDSM) technologies, timing margins plays a more decisive role in the capability and market into which the resulting chips can be sold. For example, as the timing margin is reduced, one potential result is a lower yield, which may be necessary for certain high end applications. In other situations, if a chip runs adequately at lower speeds, it can be adopted for lower end applications, such as through an associated speed grading process. This can significantly improve the overall yield since a greater percentage of the fabricated chips populate the market.

Various factors can lead to reduced timing margins for the DSM and other technologies. For example, some manufacturers emphasize getting chips on the market quickly, potentially at the expense of improving the time margin. Additionally, process variations can result in a narrowing of timing margins. For example, if a process has not yet matured, which is the case in many newer cutting edge technologies, there can be a wide variation in a timing performance depending on process comers that the devices experience through fabrication. Process variations can also occur for more mature processes. Reasons for process variations include, for example, distributed defects, such as mask alignment, as well as ion implantation or oxide thickness variations. Yet another factor that can result in a narrowing of timing margins is that newer cutting edge technologies for DSM and UDSM often push existing tools to or even beyond their limits. For example, existing tools may not be able to model accurately the effect of different parasitics, requiring extraction tools to run over the specifications.

Manufacturers rely on numerous commercially available and proprietary tools to facilitate the process flow associated with the design synthesis and fabrication of semiconductor devices. Many existing techniques and tools can be expensive to implement due to the substantial time and/or capital investment required. For post-fabrication, in particular, existing tools and techniques tend to provide little information on timing information, such as how fast a chip can actually run. Typically, conventional post-fabrication testing approaches tend to focus on determining on whether a chip fails for its intended application, providing pass/fail results.

It is desirable to provide systems and methods that can evaluate structure and/or operational characteristics of an IC chip. It is desirable to provide an approach that can be implemented efficiently and cost effectively yet still provide desired information (e.g., about the performance and/or process variations associated with the chip).

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates generally to evaluating an integrated circuit (IC) chip. A set of critical paths are determined for a design of the IC chip, at least some of which paths are determined according to timing characteristics for the design (e.g., timing margin or slack). A plurality of sets of test patterns are generated for the set of critical paths and for different performance criteria. The plurality of sets of test patterns are then applied to the IC chip to provide corresponding test data for one or more of the sets of test patterns.

The resulting test data can be utilized to improve the chip yield for the IC design. For example, the test data can be evaluated to ascertain performance characteristics of the IC chip (e.g., potential operating speed via speed grading). The test data can also be utilized to determine an indication of process variations for the IC chip, a wafer die, as well as variations across wafer lots. Such an approach can be implemented as computer-executable instructions on one or more computer devices, including automatic test equipment. Because the approach employs sets of test patterns for a selected subset of data paths of the IC, it can be implemented efficiently and economically to discern information that can help improve overall yield, even as speed and device densities continue to increase.

The following description and the annexed drawings set forth certain illustrative aspects of the invention. These aspects are indicative, however, of but a few of the various ways in which the principles of the invention may be employed. Other advantages and novel features of the invention will become apparent from the following detailed description of the invention when considered in conjunction with the drawings.

### BRIEF DESCRIPTION OF THE DRAWINGS

FIG. 1 depicts a block diagram of a system to test and evaluate an IC design in accordance with an aspect of the present invention.

FIG. 2 depicts a graph depicting slack characteristics for a plurality of paths in accordance with an aspect of the present invention.

FIG. 3 is a graph depicting waveforms associated with part of a testing process implemented in accordance with an aspect of the present invention.

FIG. 4 depicts an example of a path of part of an IC chip on which testing is being implemented in accordance with an aspect of the present invention.

FIG. 5 is a flow diagram illustrating a methodology for generating test patterns in accordance with an aspect of the present invention.

FIG. 6 is a flow diagram illustrating a chip grading methodology implemented in accordance with an aspect of the present invention.

FIG. 7 is a flow diagram illustrating use of target patterns to facilitate evaluation of chip performance in accordance with an aspect of the present invention.

FIG. 8 is a flow diagram illustrating a methodology for ascertaining potential performance characteristics in accordance with an aspect of the present invention.

### DETAILED DESCRIPTION OF THE INVENTION

The present invention relates generally to systems and methods that can be utilized to ascertain an indication of chip performance and/or process variations that might affect chip performance. One or more sets of test patterns or test vectors are generated (e.g., by a test pattern generator) according to desired target performance criteria for one or more critical paths in a chip (e.g., based on timing margin or slack characteristics). The test patterns are utilized to ascertain timing information associated with the respective critical paths of the IC chip. For example, test data can be generated and evaluated to ascertain timing information indicative of the potential speed of the chip. Additionally or alternatively, the test data can provide an indication of potential process variations associated with fabrication of the IC chip. Thus, certain information can be fed back to the fabrication process to further improve associated timing margins for one or more specific regions of the die.

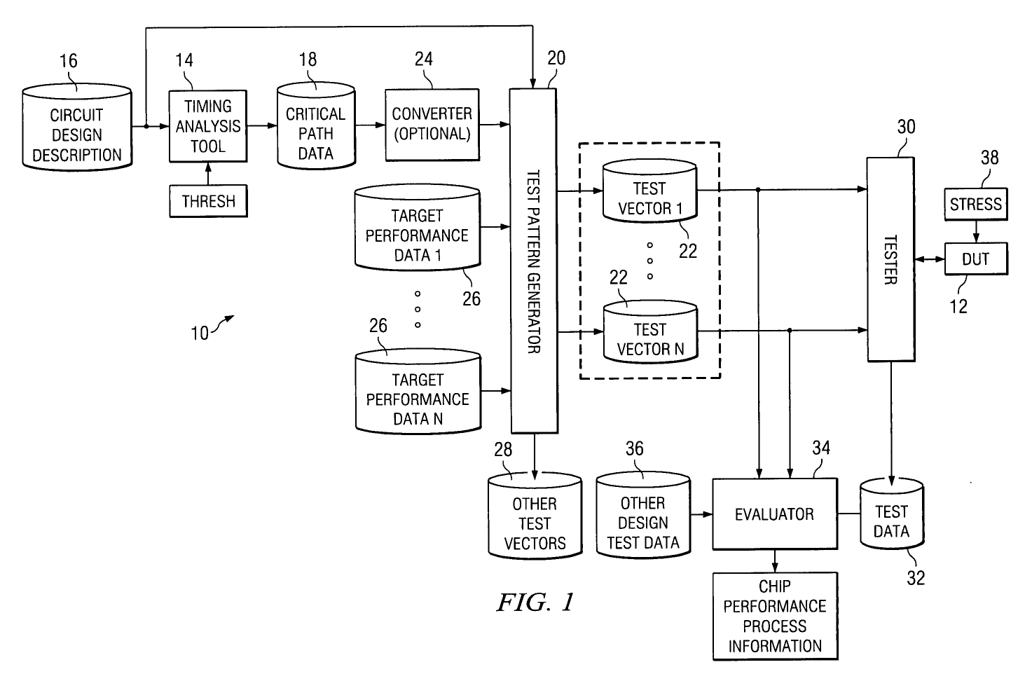

FIG. 1 depicts an example of a system 10 that can be utilized to facilitate post fabrication testing in accordance with an aspect of the present invention. The system 10 is particularly useful for semiconductor devices fabricated in the deep submicron (DSM) (e.g., less than 0.2 micrometers) and ultra DSM (UDSM) technologies. The system 10 can utilize commercially available computer aided design tools and testing equipment as well as proprietary technology. It will be appreciated that the approach described herein enables a manufacturer to derive useful information about the structure, operation and/or process variations associated with a device under test (DUT) 12, such as one or more IC chips. The process variations further can vary across internal regions of the chip, across different ICs fabricated in the same wafer die as well as across different wafer lots.

The system 10 includes a timing analysis tool 14 that performs timing analysis (e.g., static timing analysis) on a circuit design. For example, the analysis tool 14 employs a circuit design description 16 that characterizes a circuit in a defined description language. The circuit design description 16, for example, provides information about the circuit design, such as transistor netlists of standard cells, the design netlists, the design parasitic data as well as timing constraints associated with the design. According to one aspect of the present invention, the timing analysis tool 14 employs a circuit design description 16 for synthesis-based gate-level designs, which can be characterized in any suitable hardware description language (e.g., Verilog, VHDL, etc.).

The timing analysis tool 14 generates critical path data 18 for one or more paths of the circuit design 16. According to an aspect of the present invention, the critical path data 18 includes those data paths having timing margins (or slack) less than or equal to a threshold timing criteria, indicated at THRESH. That is, the critical path data 18 defines a set of critical paths in a circuit design having potentially worst case operating characteristics. The set of critical paths of the circuit design can be identified based on a comparison of slack characteristics determined by the timing analysis tool relative to the slack limit indicated by the THRESH criteria. In addition to those paths having timing margins (or slack) below the threshold defined by the THRESH criteria, the critical path data 18 can also include an indication of those paths having worst case design rule margins, such as may be identified by the circuit designer.

By way of example, the timing analysis tool 14 can be any commercially available or proprietary static timing analysis tool. Examples of such systems include PrimeTime and PathMill, both commercially available from Synopsis, Inc., as well as timing analysis tools available from other vendors, such as Cadence Design Systems, Inc. and Mentor Graphics Corp.

The system 10 also includes a test pattern generator 20. The test pattern generator 20 employs the critical path data 18 as well as the circuit design description 16 to generate one or more test vectors 22, indicated at test vector 1 through test vector N, where N is an integer greater than or equal to 1. Each test vector is a set of plural test patterns. Thus, the terms test vector and set of test patterns are used interchangeably herein. Depending on the compatibility between the type of test pattern generator 20 and the timing analysis tool 14, an optional converter 24 can be utilized to translate the critical path data 18 into a format suitable for the test pattern generator 20.

The test pattern generator 20 also receives target performance data 26, indicated at target performance data 1 through target performance data N. The test pattern generator 20 utilizes each respective target performance data 26 to generate a corresponding one of the test vectors 22. The target performance data 26, for example, contains test information that defines performance criteria for each of the test vectors 22, which are to be implemented by an associated test program. For example, the target performance data 26 can include information, such as a test clock frequency, scan chains, input/output requirements, and test timing information. The target performance data 26 can be provided in a standard test interface language (STIL), such as a STIL procedure file (e.g., a .spf file). Thus, the test pattern generator 20 generates the test vectors 22 based on the target performance data, the critical path data 18 and the circuit design description 16, such as the netlist associated with the circuit design. By way of example, the test pattern generator 20 can implement the TETRAMAX® automatic test pattern generator, which is commercially available from Synopsis, Inc. of California.

It is to be understood and appreciated that the test pattern generator 20 further can be utilized to generate other test vectors 28, such as can be utilized to implement other known types of testing on the DUT 12. For example, the other test vectors 28 can be utilized in connection with IDDQ testing, such as a set of high volt coverage vectors designed to avoid excessive current during the quiescent state of the DUT. For example, IDDQ testing is commonly used in defect testing of integrated circuits containing CMOS devices. IDDQ testing is performed by stopping clock signals applied to the DUT. This places the DUT in a quiescent state in which the current flow through the DUT is characterized by a so-called “IDDQ” quiescent current in contrast to the “IDDD” dynamic current which flows during normal clocked operation of the DUT. Various defects can be detected by measuring IDDQ current flow through the DUT when the DUT is in the quiescent state, and comparing the measured IDDQ value to predefined values representative of IDDQ current values for similar devices which are known to be either defective or defect-free. Additionally or alternatively, the other test vectors 28 can be designed to simulate other fault or operating conditions that can be applied to the DUT 12 to ascertain whether the device passes or fails the minimum desired operating parameters.

A tester 30 is operative to implement delay path testing on the DUT 12 utilizing the test vectors 22, 28 according to an aspect of the present invention. The tester 30, for example, loads the test vectors 22 into associated memory (not shown) and runs the plurality of patterns associated with each test vector 22 on the DUT 12. As mentioned above, the test vectors 22 include plural test patterns that can be applied to the DUT 12 to ascertain different levels of performance of the DUT, as characterized by the circuit design description 16. The tester 30 in turn generates associated test data 32 based on applying the test vectors 22 to the DUT 12. The test data 32 can also include data derived from applying the other test vectors 28 to the DUT 12.

Because, in accordance with one aspect of the present invention, only a selected subset of critical paths in the circuit design are being tested in the system 10, the tester 30 can turn ON or OFF certain paths and/or set certain cells to desired operating states to ensure proper scanning and capturing of associated test data for the selected critical paths, as described by the test vectors 22. As mentioned above, the critical paths being tested correspond to those data paths having a slack characteristic within a limit, which can be selected by the designer or other personnel associated with the process flow according to the particular DUT 12 and its intended application. Additionally, because the target performance data 26 can include setting different clock speeds (at-speed frequencies) for the respective test vectors 22, the test data 32 can provide an indication of chip performance over a plurality of clock frequencies for the critical paths.

An evaluator 34, which can be hardware, software or a combination of hardware and software, employs the test data to ascertain information about chip performance and/or process variations associated with the DUT 12. The evaluator 34, for example, can compare the actual test data 32 derived from an application of the test vectors 22 relative to expected data derived by the timing analysis tool 14 or another design tool (not shown), which comparison design data is indicated collectively at 36. Additionally, the location of the various critical paths on the DUT 12 can be correlated with the captured test data 32 to help ascertain process variations across the DUT 12 (e.g., a chip), across the die as well as across multiple wafer lots. This region specific information further can be fed back to adjust corresponding process parameters to mitigate variations in subsequent fabrication processes. For example, process parameters can include mask alignment, etching parameters, oxide or other dielectric thicknesses (e.g., capacitance affecting delay characteristics) and so forth. Additionally, the evaluator 34 can compare or evaluate the test data 32 for each respective test vector 22 and implement corresponding grading (e.g., speed grading) of the DUT 12 to improve the chip yield.

Traditionally, after fabrication of an IC chip, the overall yield may be significantly decreased by discarding those units due to the number of potential paths having insufficient timing margins. Alternatively, a determination can be made as to which chips can run at a lower speed, but are still usable. By implementing path delay testing on the fabricated IC chips according to an aspect of the present invention, the determination of which chips may be usable at lower speeds is facilitated. The approach described herein further can provide more information as to potential timing margins and potential operating speeds in an economic and efficient manner.

Additionally or alternatively, one or more stress tests can be employed to apply stress 38 (e.g., elevated electrical biasing and/or increased temperature) on the DUT 12 to facilitate determining an impact (e.g., degradation) in performance of the DUT 12. For example, the stress test can be associated with burn-in or other high stress conditions to simulate extended operation of the DUT 12. The performance of the DUT 12 generally is limited by its weakest performing area, such as usually is associated with one or more of the critical paths, as indicated by the data 18. By way of example, the tester 30 can apply the respective test vectors 22 sequentially to the DUT 12 and generate a first set of test data prior to application of the stress 38. The stress 38 can be applied to the DUT 12 and then the tester 30 applies the same set of test vectors 22 on the DUT to generate a second set of test data. This process of applying stress and application of the test vectors 22 can be repeated to obtain respective sets of associated test data over a plurality of test cycles. It will be appreciated that the stress 38 can be applied by the tester 30, such as by providing elevated electrical biasing at associated test sockets of the tester.

The evaluator 34 can analyze and correlate the respective sets of test data, including pre-stress test data as well as post-stress test data, to ascertain the impact on performance of the DUT 12. The evaluator 34 can employ empirical and/or statistical methods, for example, determining whether there is any degradation in performance, such as in the operating speed, as well as quantify the amount of such degradation based on the test data obtained over the plurality of test cycles.

The impact on performance further can include identifying a particular location on the DUT 12 that experiences degradation in performance or is otherwise adversely impacted by the application of stress 38. The identified location, for example, can correspond to a critical data path in the DUT 12, as described herein. The location information and details about the impact on performance at such location (e.g., the critical path) can be correlated to ascertain one or more potential process variations capable of causing such defect. For example, a library of process parameters associated with the fabrication of the DUT 12 (e.g., IC chip) can be generated to associate (or map) known process parameters with their potential impact on device performance. Thus, by determining an impact on performance of the critical paths, such information can be linked to one or more process parameters. As a result, adjustments can be made to such process parameters to improve performance, along at least the identified critical paths.

Those skilled in the art will understand and appreciate various types of test equipment that can be utilized to apply the test cases on the DUT or more than one DUT 12 in accordance with an aspect of the present invention. Examples include various automatic test equipment (ATE) offerings from manufacturers such as Advantest Corporation, Credence Systems Corporation and LTX corporation to name a few.

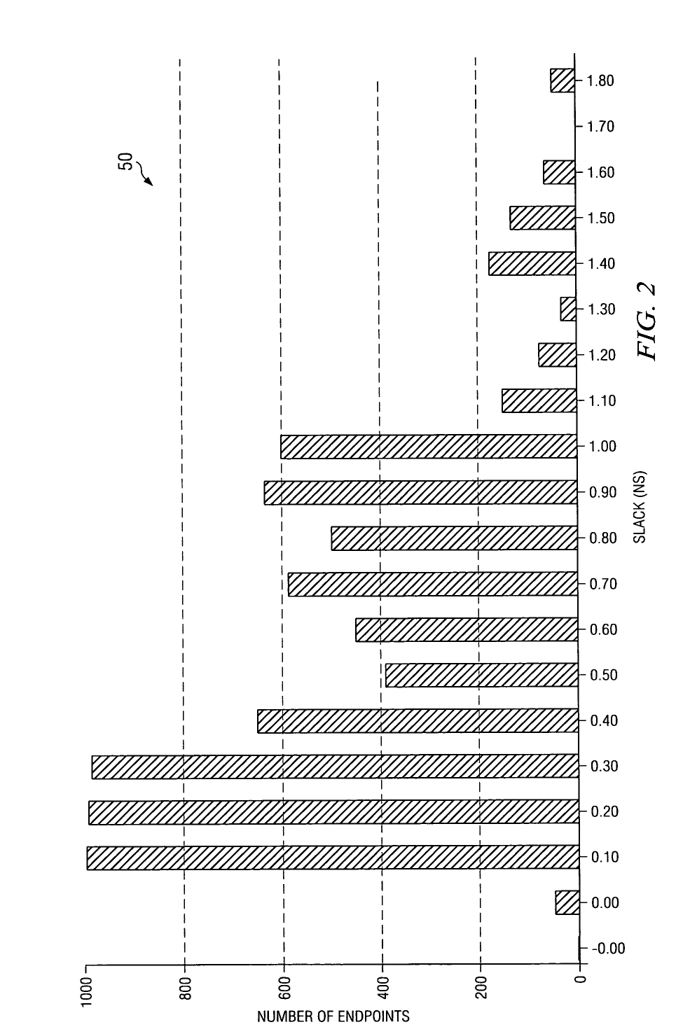

FIG. 2 is a graph illustrating slack characteristics, indicated at 50, for a plurality of path endpoints of a circuit design. As depicted in FIG. 2, there are hundreds of endpoints with a slack of less than approximately 0.1 nanoseconds, as is the case for many designs. As used herein, a timing margin corresponds to the positive slack associated with each end point. The slack characteristics 50, for example, can be generated by a timing analysis tool, such as a static timing analysis system, as described herein (e.g., the tool 14 of FIG. 1). The timing analysis tool further can employ the slack characteristics 50 to identify those paths associated with a slack below a predetermined limit or threshold (e.g., about 0.1 nanoseconds). Paths having slack less than or equal to this threshold can be flagged and identified as critical paths. The paths can be identified by path number in the IC design or, alternatively, by a netlist that identifies the devices and/or cells in the particular path. These critical paths, in turn, can be utilized to generate delay test patterns for use in implementing delay path testing of IC chips in accordance with an aspect of the present invention.

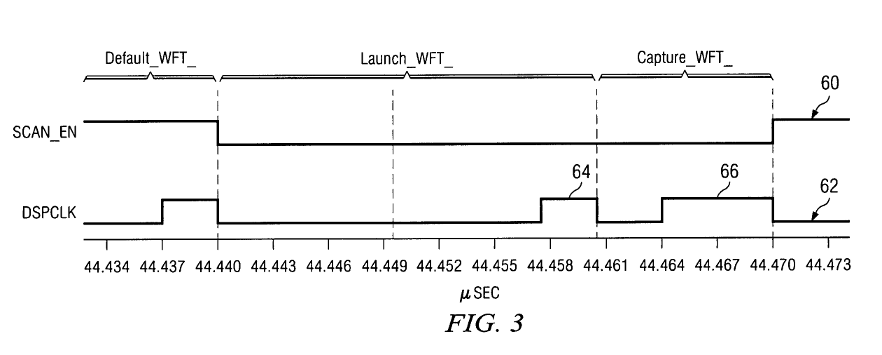

FIG. 3 illustrates a scan enable waveform (SCAN_EN) 60 and a chip clock waveform (DSP_CLK) 62 that can be utilized in a path delay fault test process implemented in accordance with an aspect of the present invention. The path delay fault test exercises one or more selected critical paths at-speed (e.g., at or near a maximum operating speed of the chip) to detect whether the path is too slow, such as because of manufacturing defects or process variations. The path delay fault testing targets physical defects that might affect distributed regions of a chip, such as may form part of an identified critical path. This is to be contrasted with other testing methodologies, including for example, stuck-at, IDDQ and transition delay faults, which typically target at single-point defects.

By way of example, a path delay fault can be tested by applying a first vector that initializes the path prior to applying a launch event, typically a clock pulse. In particular, as depicted in FIG. 3, after the scan enable signal 60 is asserted low (corresponding to the capture mode), the first clock pulse 64 is asserted corresponding to the launch event. The first clock pulse 64 occurs at a time that allows for the scan enable signal 60 to transition, which corresponds to a slow capture event. The first clock pulse 64 is generates a second vector that propagates a logic transition along the entire critical path being tested. A second clock pulse, indicated at 66, occurs one at-speed clock cycle after the launch clock pulse 64. The second clock pulse 66, which corresponds to the at-speed capture, is utilized to capture the resulting transition at the end point of the critical path 100.

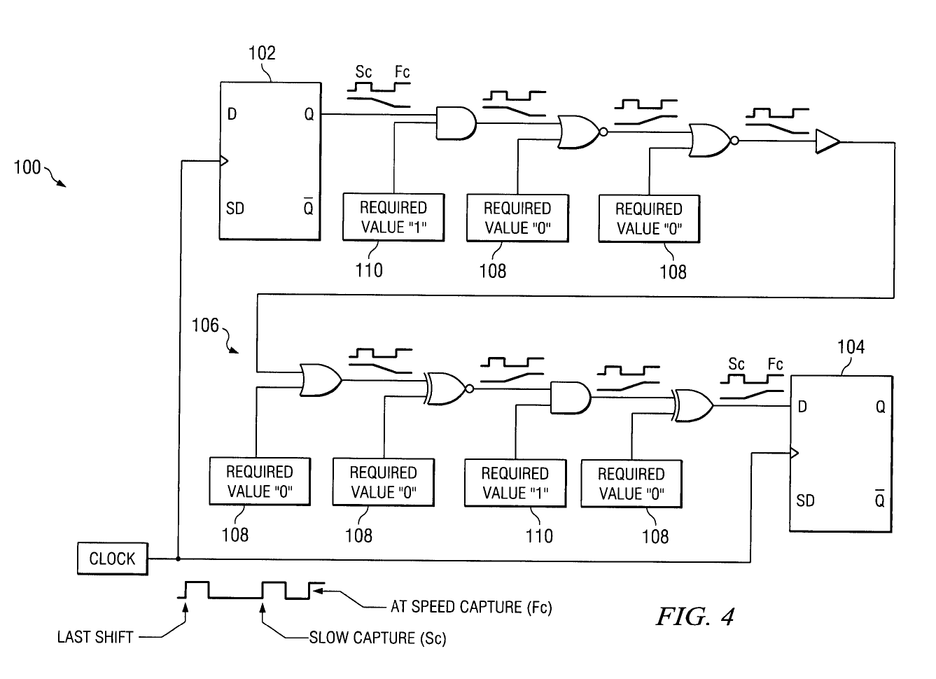

FIG. 4 depicts an example of a data path 100, such as corresponding to a critical path (e.g., a worst-case timing path) derived by a timing analysis tool at a predetermined maximum frequency. While a single critical path 100 is depicted in FIG. 4, it will be understood and appreciated that a plurality of such paths typically are identified and utilized to generate the path delay test patterns, as described herein. In addition to those paths having a slack less than a predetermined slack limit, the critical path data can also include one or more paths having worst case design rule margins. In this way, the critical path data can include more than just those identified by the timing analysis tool.

In the example of FIG. 4, the path 100 is defined by endpoints that include a launching flip-flop 102 and a capturing flip-flop 104 (e.g., DQ flip flops). Each of the flip-flops 102 and 104 receives a clock signal CLOCK. The CLOCK signal thus drives the testing or analysis of the path 100 according to the test patterns generated for the critical path. The Q output of the flip-flop 102 drives the path and the D input of the flip-flop 104 receives the end signal being captured. A plurality of gates, collectively indicated at 106, are connected between the endpoint flip-flops 102 and 104 corresponding to logic implemented by the path 100.

The timing patterns can be generated to control inputs to various gates to help ensure propagation of the signal through the path 100. Thus, the logic elements 106 and flip flops 102 and 104 that define the path 100 can be programmed by shifting in a proper value to ensure the required value exists at the end of slow capture. In the example of FIG. 4, the logic blocks 108 supply required values of 0 (or LOW) and the blocks 110 provide a required values of 1 (or HIGH). The control data is launched at the slow capture edge, indicated SC, and captured by the capturing flip-flop with the at-speed capture edge, indicated at FC for each of the logic elements 106.

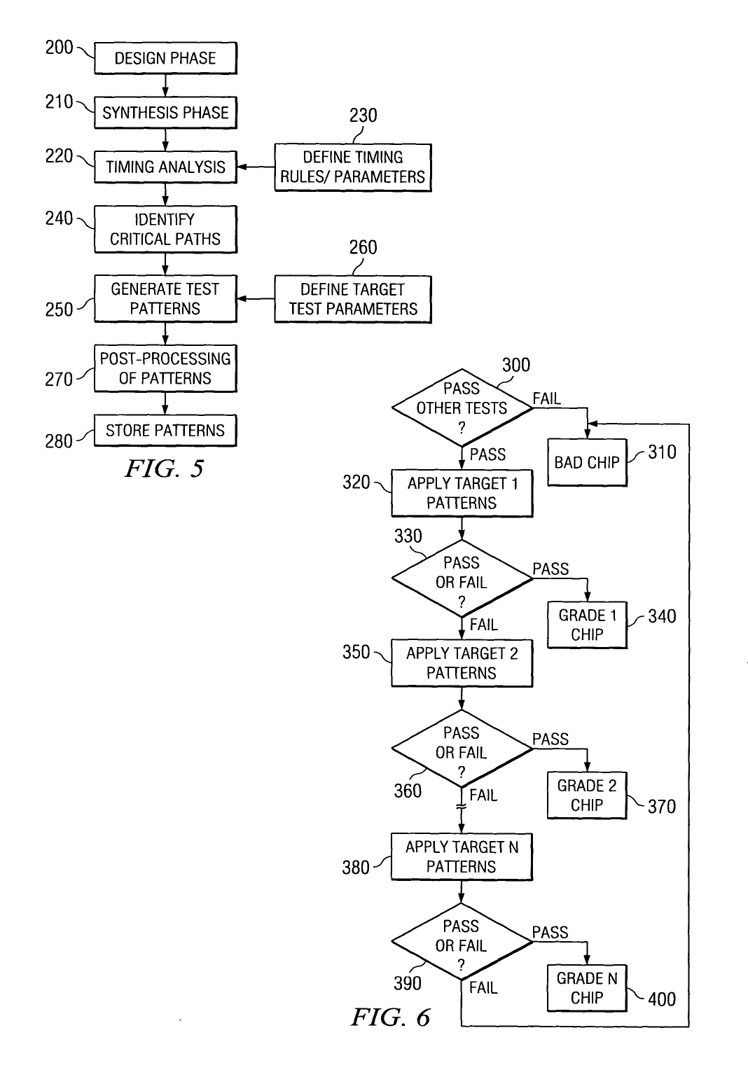

In view of the structural and functional examples shown and described above, methodologies that may be implemented in accordance with the present invention will be better appreciated with reference to the flow diagrams of FIGS. 5, 6, 7 and 8. While, for purposes of simplicity of explanation, the methodologies are shown and described as a executing serially, it is to be understood and appreciated that the present invention is not limited by the order shown, as some aspects may, in accordance with the present invention, occur in different orders and/or concurrently from that shown and described herein. Moreover, not all illustrated blocks may be required to implement a methodology in accordance with the present invention. It is further to be appreciated that the methodologies or one or more aspects thereof could be implemented as hardware, software (e.g., computer executable instructions stored in a computer readable medium or running on a computer), or as a combination of hardware and software.

FIG. 5 illustrates a methodology that can be utilized to generate test patterns for use in path delay testing in accordance with an aspect of the present invention. The methodology begins at 200 with a design phase for a semiconductor device. For example, the semiconductor device can fabricated using DSM or ultra DSM (UDSM) technologies, such as for a digital signal processor (DSP), an application specific integrated circuit (ASIC) and the like. Additionally, in the design phase (200) of the semiconductor device, additional digital logic can be incorporated into the design to facilitate test data generation and response analysis in accordance with an aspect of the present invention. For example, the additional logic can be utilized to facilitate the use of multiple clock speeds during testing, based on which desired performance characteristics (e.g., speed grading) of the chip can be ascertained.

After the design phase, the methodology proceeds to 210 in which a synthesis phase is implemented. The synthesis phase (210), for example, can include generation and optimization of a design description, such as by converting a high level language to a lower level circuit design (e.g., a gate level or register transfer level (RTL) description). The synthesis phase (210) further can include optimization of the cells or gates, as is know in the art. The synthesis stage can be facilitated by implementing scan insertion and/or design-for-test (DFT) analysis (e.g., using one or more synthesis tools, which can perform block level or chip level synthesis). Once the circuit design has been synthesized at 210, the methodology proceeds to 220.

At 220, timing analysis is performed on the circuit design, which design can be provided in the form of netlist data and other associated criteria. Timing rules and timing parameters are provided at 230 to facilitate implementing the timing analysis 220. The timing rules and parameters, for example, define timing constraints associated with the timing analysis being performed at 220. Such constraints can include particular delay formats, such as a standard delay format (SDF), delay standard parasitic format (DSPF) or other interface formats according to the tool implementing the timing analysis. Additionally, the timing rules and parameters further can include a setload that defines design rule violations and other load information that is to be applied to all nets in the netlist data provided by the synthesis phase at 210. For example, the setload can include performing hyper extraction on the final DEF file that employs an extraction rule file. This provides the resulting parameters and rules in the desired format (RSPF, SDF, etc.).

The timing analysis (220) employs the netlist and the timing rules/parameters at 230 to determine a set of one or more critical paths of the circuit design at 240. The critical paths can correspond to those paths exhibiting slack characteristics below a predefined slack limit, which can be a threshold value defined at 230. The slack limit can be set by a design engineer or it can be determined empirically or statistically based on an evaluation of the slack characteristics determined by the timing analysis for the paths in the design. Additionally or alternatively, the critical paths can include those paths designated by the designer as having potentially narrow timing margins.

After identifying a list of the critical paths, at 250, corresponding test patterns are generated. Each set of test patterns typically includes a plurality of signal patterns, which can be utilized to exercise associated critical paths (240) of corresponding integrated circuit chips. A plurality of sets of test patterns can be generated for respective target test parameters defined at 260. The target test parameters, for example, can include clock speed for each of a plurality of desired target speeds of the IC chip being designed, as well as other performance-related operating parameters. The target speeds, for example, might be determined by marketing personnel or other design personnel associated with the design and/or fabrication of the device. Various types of test pattern generation equipment could be employed to generate the respective sets of test vectors at 250.

The test patterns generated at 250 can experience further post processing at 270, which can include processing the data files that define the patterns, such as provided in a test data language (TDL). For example, the processing can include aligning edges of associated timing or clock signals to facilitate subsequent application of the test patterns. Additionally, the post-processing at 270 can include simulation of the patterns (before and/or after some post-processing) to verify that the test patterns will function in the desired manner when subsequently applied to a fabricated IC chip embodying the circuit design. The simulation can apply the test patterns relative to the circuit design using another design tool, for example. Additionally, the post processing at 270 can include formatting or converting the test patterns into a different desired format according to the particular test equipment that is to utilize the test patterns. The post-processed patterns are then stored at 280.

FIG. 6 depicts an example in which test patterns are utilized for chip grading in accordance with an aspect of the present invention. The methodology of FIG. 6 begins at 300 in which a determination is made as to whether the unit (e.g., IC chip) under test has passed one or more other preliminary post-fabrication tests. Those skilled in the art will appreciate various tests that can be utilized to ensure proper operation of IC chips that can be utilized (e.g., IDDQ testing or other normal chip test VOL, VOH, slow scan, burn-in etc.).

In the event that the chip has failed such test (FAIL), the methodology proceeds to 310 identifying or marking the unit as a bad chip. If it has passed such other tests at 300, the methodology proceeds to 320. At 320, TARGET 1 patterns are applied by a tester to the unit under test. In this example, it is assumed that there are N sets of target patterns to be utilized, where N is an integer greater than or equal to 1. Additionally, it is assumed that TARGET 1 patterns correspond to a faster speed than the TARGET N patterns. After the TARGET 1 patterns have been applied at 320, a determination is made at 330 as to whether the chip has passed or failed the testing with the TARGET 1 patterns. If the unit under test has passed (PASS), the methodology proceeds to 340 in which the chip is graded as a grade 1 chip, which in this example corresponds to a highest grade.

In the event that the chip has failed operating within expected operating parameters for the TARGET 1 patterns (FAIL), the methodology proceeds to 350. At 350 TARGET 2 patterns are applied to the chip by the testing apparatus. At 360, a determination is made as to whether the chip passes or fails the TARGET 2 patterns applied at 350. If the chip passes the test with that TARGET 2 patterns (PASS), it can be identified as a grade 2 chip having the next particular performance level. For example, a grade 1 chip has a faster useable operating speed than the grade 2 chip at 370. In the event that the chip fails to operate within operating parameters for the TARGET 2 patterns applied at 350 (fail), the methodology can proceed from 360 to 380.

As mentioned above, there can be any number of N possible levels of performance grading. The break in the transition between 360 to 380, as shown in FIG. 6, thus is intended to depict other possible target patterns that can be utilized, which depends on the number N of available target patterns that have been generated in accordance with an aspect of the present invention.

At 380, TARGET N patterns are applied to the chip by the tester. At 390, another determination is made as to whether the chip operates within expected operating parameters in response to, application of the TARGET N patterns at 380. If the chip passes the testing implemented with the TARGET N patterns (PASS), the methodology proceeds to 400. At 400, the chip can be graded as a grade N chip. As mentioned above, in this particular example, a grade N chip is inferior to a grade 2 chip, which is inferior to a grade 1 chip. If the chip fails the testing implemented with the target N patterns, the methodology returns from 390 to 310 in which the chip is further identified as a bad chip, which can be discarded. Those skilled in the art will understand and appreciate that employing a plurality of test patterns generated for a plurality of desired clock speeds for a limited number of selected critical paths on the IC (e.g., a collection of worst case paths), grading of chips can be facilitated in accordance with an aspect of the present invention.

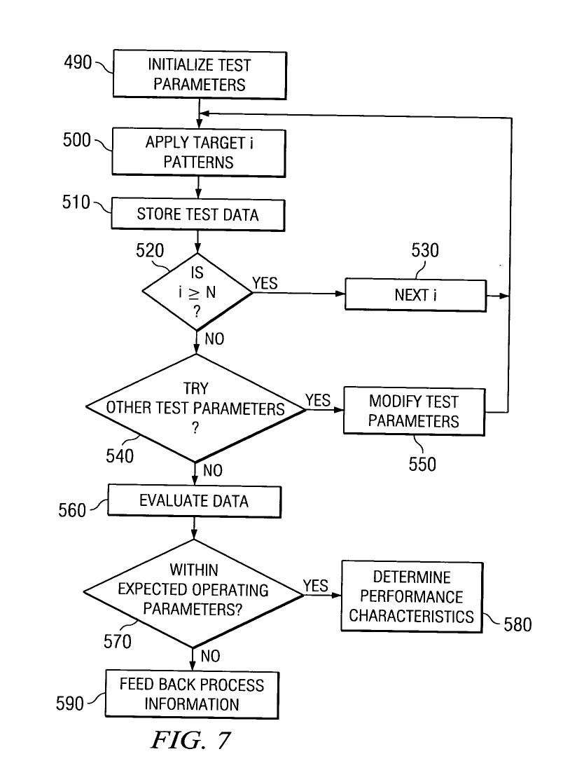

FIG. 7 illustrates an example of a methodology that can be employed to ascertain process variations associated with an IC chip in accordance with an aspect of the present invention. The methodology begins at 490 in connection with initializing the testing process, which can include instantiating applicable objects and setting applicable parameters to their starting values. The methodology employs a plurality of sets of path delay target patterns that have been generated for a subset of critical paths of the circuit design. As described above, for example, the subset of paths to which the sets of target patterns relate includes those paths having timing margins or slack below a corresponding slack limit or selected paths otherwise deemed problematic by the designer.

From 500 the methodology proceeds to 500 in which TARGET i parameters are applied to one or more chips under test, where i an integer from 1 to N and where N denotes the number of available sets of test patterns. Each set of test patterns correspond to delay test patterns (or a test vector) generated for a plurality of different target operating conditions to facilitate gauging performance of an associated chip or chips.

From 500 the methodology proceeds to 510 in which the associated test data generated by the test apparatus in response to application of TARGET i patterns is stored. From 510, the methodology proceeds to 520 in which a determination is made as to whether i is greater than or equal to N. That is, are there any additional sets of test patterns that are to be applied? When additional test patterns exist at 520 (YES), the methodology proceeds to 530 in which i is incremented to its next value. The methodology then returns to 510 in which the next set of TARGET i test patterns are applied to the chip or chips (510) and the corresponding test data is stored (520). The methodology can loop through 510 and 530 over the available sets of test patterns. If the determination at 520 is negative, the methodology proceeds to 540.

At 540, another determination is made as to whether there are any other test parameters for which the N sets of target patterns are to be applied. Examples of new test parameters can include a modified supply voltage, different clock speeds (e.g., associated with internal and/or external clocks of the IC chip) as well as other parameters that may effect operation of the chip, such as due to process variations. If other test parameters exist, the methodology proceeds to 550 in which the test parameters are modified accordingly. The methodology then returns to 510 in which the N sets TARGET i patterns are applied using the new test parameters. If the determination at 540 is negative, indicating that no additional test parameters exist, the methodology proceeds to 560.

At 560, the stored test data can be evaluated. This evaluation, for example, can include analyzing the respective test data to ascertain various characteristics associated with structural or functional operation of the chip. Additionally, the evaluation can include a determination of associated process conditions that may correspond to detected variations in the stored test data. From 560, the methodology proceeds to 570.

At 570, a determination is made as to whether the evaluation of the test data for the chip indicates that the chip is within expected operating parameters. If the chip is within expected operating parameters, the methodology can proceed to 580. At 580, performance characteristics can be determined. For example, the performance characteristics can correspond to timing information or speed of the chip indicating how fast the chip can run. Additionally or alternatively, the performance characteristics can include maximum supply voltages, one or more internal or external clock speeds, and other criteria that may also effect operation of the chip.

If the determination at 570 is negative, indicating that the detected operation is not within expected operating parameters for at least some regions of the chip, the methodology proceeds to 590. At 590, the detected abnormalities or operating characteristics outside of expected operating parameters can be correlated and fed back as process information. This process information can be utilized by a design engineer or automatic process control to modify fabrication process conditions accordingly. As a result of employing the delay test patterns for a selected set of critical paths, as described herein, the overall yield of the chip can be improved based on the performance characteristics determined at 580. Additionally or alternatively, process variations can be mitigated during subsequent processing by modifying process parameters based on the information derived from the evaluation at 560, which is fed back at 590 for implementing desired process adjustments.

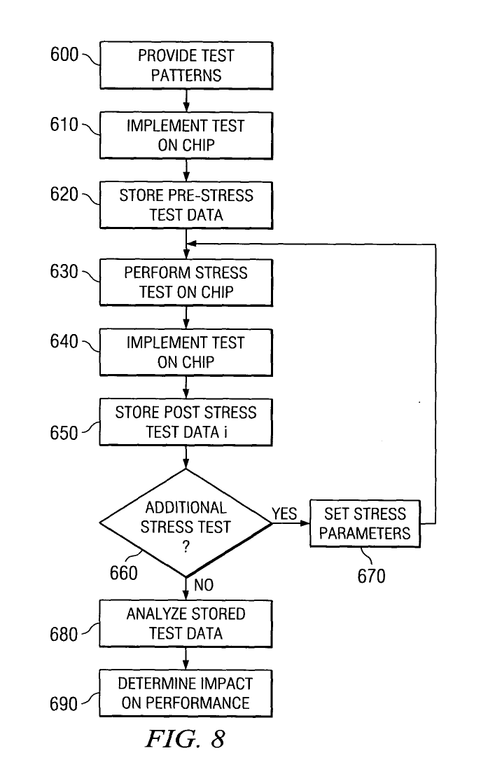

FIG. 8 is a flow diagram illustrating a methodology that can be utilized to ascertain performance characteristics on one or more chips in accordance with an aspect of the present invention. The methodology begins at 600 in which test patterns are provided. The test patterns can be generated according to the methodology of FIG. 5. For example, plural sets of such test patterns can be provided at 600 for a selected subset of critical paths, each set of patterns generated employing different performance criteria, such as a different target clock frequency.

At 610, tests are implemented on one or more chips for each of the sets of test patterns provided at 600. At 620, the corresponding test data (e.g., pre-stress test data) is stored. The pre-stress test data at 620 provides a baseline against which subsequent test data can be measured or correlated to ascertain performance information about the chip.

At 630, a stress test is performed on the chip. For example, the stress test can include operating the chip for a predetermined time period at high stress conditions, such as including a higher supply voltage, such as typically associated with burn-in, as well as a lower that at-speed clock speed to maintain operating states of chip devices for increased time periods. The same test apparatus that implements the chip testing at 610 can include facilities equipped with test sockets, electrical biasing, elevated temperature provision, and other test-related equipment to implement the stress tests. Alternatively, separate equipment can be utilized to implement the stress test on the chip or chips under test.

After the stress test has been performed, at 640, another set of tests are implemented on the chip based on the test patterns provided at 600. These tests can be characterized as post-stress tests. The post-stress test data is stored at 650. As described below, differences between pre-stress and post-stress data provides an indication on the impact that stress or extended normal operating conditions may have on the critical paths as well as on the chip as a whole.

At 660, a determination is made as to whether additional stress tests are to be performed on the chip. If the determination at 660 indicates additional stress tests are to be performed (YES), the methodology proceeds to 670. At 670, the stress test parameters for the next stress test are set. For example, different stress test parameters can be implemented such as different supply voltages, clock frequencies and the like. Alternatively, some or all of the stress tests can employ the same stress test parameters. From 670, the methodology returns to 630 in which the next stress test is performed and corresponding chip testing (640) and storing of post-stress data (650) is performed. The methodology can loop between 630 and 670 depending on the number of stress test being implemented on the chip or other DUT. If the no additional stress tests and chip testing are to be performed at 660 (NO), the methodology proceeds to 680.

At 680, the stored test data, including pre-stress test data at 620 and all post-stress data at 650 is analyzed. The analysis at 680, for example, can include correlating detected timing variations for each of the plurality of critical paths for which the target test patterns have been developed. By evaluating the timing data associated with the critical paths deemed to include the worst case potential data paths, a determination of the impact on chip performance at 690 is facilitated. For example, the impact on performance at 690, for example, includes ascertaining an amount of speed degradation along the critical paths of the chip in response to the stress test or tests performed at 630. By characterizing degradation in performance in response to such stress tests, a reasonable determination of projected life expectancy and performance can be deduced based on the analysis at 680. The determination on the performance impact at 690 further can be utilized to ascertain potential process variations that can effect the detected degradation in performance. Thus, the information determined at 690 can be fed back to adjust process parameters during fabrication of the chip. It is to be understood and appreciated that the foregoing methodologies can be applied to determine regional information across a given chip, across an entire die as well as variations across wafer lots.

What has been described above are exemplary embodiments of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method to facilitate evaluating an integrated circuit (IC) chip comprising:
determining a set of critical paths for a design associated with the IC chip, at least some of the critical paths being determined based on timing characteristics thereof;
generating a plurality of sets of timing test patterns for the set of critical paths, each set being generated according to desired performance criteria; and
applying at least one of the plurality of sets of test patterns to the IC chip to provide corresponding test data indicative of performance-related characteristics of the IC chip.

2. The method of claim 1, the timing characteristics including a timing threshold indicative of slack between endpoints of an associated path of the design associated with the IC chip, the set of critical paths including data paths of the design associated with the IC chip having a slack less than that defined by the timing threshold.

3. The method of claim 1, the determination of the set of critical paths further comprising performing static timing analysis on the design associated with the IC chip to provide slack characteristics for paths of the design associated with the IC chip.

4. The method of claim 3, the determination of the set of critical paths further comprising:
defining the timing characteristics as a slack limit; and
identifying the critical paths of the design associated with the IC chip based on a comparison of the slack limit relative to the slack characteristics provided by the static timing analysis for paths of the design associated with the IC chip.

5. The method of claim 1, the desired performance criteria of each set of the test patterns further comprising a target speed related characteristic.

6. The method of claim 1, further comprising grading a performance characteristic of the IC chip based on the test data for at least one set of the plurality of sets of test patterns.

7. The method of claim 1, the application of the at least one of the plurality of sets of test patterns further comprising:
applying a first set of the plurality of test patterns to the IC chip, the desired performance criteria associated with the first set of test patterns defining a first associated performance level for the IC chip; and
ascertaining whether the IC chip meets the first associated performance level based on the corresponding test data.

8. The method of claim 7, the application of the plurality of sets of test patterns further comprising:
if the IC chip fails the first associated performance criteria, applying at least one other set of the plurality of sets of test patterns to the IC chip, the desired performance criteria associated with the at least one other set of test patterns defining a second associated performance level for the IC chip; and
ascertaining whether the IC chip meets the second associated performance level based on the corresponding test data.

9. The method of claim 1, further comprising applying a stress to the IC chip at least one of before or after the application of the at least one of the plurality of sets of test patterns.

10. The method of claim 9, further comprising determining an impact on performance of the IC chip associated with the application of stress to the IC chip.

11. The method of claim 10, the determination of the impact on performance of the IC chip further comprising determining an impact on speed degradation of the IC chip associated with the application of stress to the IC chip.

12. The method of claim 10, the determination of the impact on performance of the IC chip further comprising identifying a location on the IC chip impacted by the application of stress to the IC chip and at least one potential process parameter capable of causing a defect at the location during fabrication of the IC chip.

13. The method of claim 1, further comprising:
evaluating the test data for the plurality of sets of test patterns to ascertain an indication of process variations associated with the fabrication of the IC chip; and
employing the indication of process variations to adjust process parameters for subsequent fabrication of IC chips based on the design associated with the IC chip.

14. The method of claim 1, further comprising evaluating the test data generated for each set of the plurality timing patterns to identify performance capabilities of the IC chip.

15. A computer-implemented method to determine performance-related characteristics of an integrated circuit (IC) chip, the method comprising:
applying a first set of test patterns of a plurality of sets of test patterns to the IC chip, the plurality of test patterns being generated for a subset of critical paths of the IC chip based on timing characteristics of the subset of critical paths ascertained from timing analysis of a design for the IC chip;
storing test data based on the application of the first set of test patterns;
repeating the application and the storing for each other set of test patterns of the plurality of test patterns; and
evaluating the stored test data for the IC chip for at least one of the plurality of sets of test patterns to provide an indication of at least one of performance-related characteristic of the IC chip.

16. The method of claim 15, the timing characteristics is a timing threshold indicative of slack between endpoints of an associated path of the design of the IC chip, the subset of critical paths including data paths having a slack less than that defined by the timing threshold.

17. The method of claim 15, each set of plurality of sets of test patterns further being generated for a target operating speed related characteristic.

18. The method of claim 15, further comprising grading a performance characteristic of the IC chip based on the stored test data for at least one set of the plurality of sets of test patterns.

19. The method of claim 15, further comprising applying a stress to the IC chip before application of at least one the first set and the other sets of test patterns.

20. The method of claim 19, further comprising determining an impact on performance of the IC chip associated with the application of stress to the IC chip.

21. The method of claim 20, the determination of the impact on performance of the IC chip further comprising determining an impact on speed degradation of the IC chip associated with the application of stress to the IC chip.

22. The method of claim 20, the determination of the impact on performance of the IC chip further comprising identifying a location on the IC chip impacted by the application of stress to the IC chip and at least one potential process parameter capable of causing a defect at the location during fabrication of the IC chip related to the impact on performance of the IC chip.

23. The method of claim 15, further comprising:
the evaluation of the stored test data further comprising evaluating the stored test to ascertain an indication of process variations associated with the fabrication of the IC chip; and
employing the indication of process variations to adjust process parameters for subsequent fabrication of IC chips based on the design of the IC chip.

24. A system to facilitate evaluating performance of an integrated circuit chip, comprising:
means for identifying a set of critical paths of the IC chip based on timing margins associated with at least some paths of the set of critical paths;
means for generating test patterns for the set of critical paths of the IC chip based on a plurality of target performance criteria; and
means for applying the test patterns to the IC chip to generate test data indicative of performance for the IC chip.

25. The system of claim 24, further comprising means for defining different desired target performance criteria for each of a plurality of sets of test patterns.

26. The system of claim 24, further comprising:
means for applying stress to the IC chip; and
means for evaluating an impact the stress has on performance of the IC chip.

27. The system of claim 24, further comprising means for ascertaining an indication of process variations associated with fabrication of the IC chip based on the test data.

28. The system of claim 24, further comprising means for ascertaining an indication of operating speed performance associated with fabrication of the IC chip based on the test data.
